(19) United States
(12) Patent Application Publication
(10) Pub. No.: US 2023/0016099 A1
(43) Pub. Date: Jan. 19, 2023

(54) Knife Switch Device

(71) Applicant: ABB Schweiz AG, Baden (CH)

(72) Inventors: John Rune West, Skien (NO); Magne Saxegaard, Porsgrunn (NO); Richard Lauritzen, Skien (NO); Ståle Talmo, Skien (NO); Stanley Lohne, Porsgrunn (NO)

(21) Appl. No.: 17/757,507

(22) PCT Filed: Dec. 2, 2020
(86) PCT No.: PCT/EP2020/084304

§ 371 Date: Jun. 16, 2022

(30) Foreign Application Priority Data
Dec. 19, 2019 (EP) 19218094.1

(51) Int. Cl. H01H 21/54; H01H 1/42

(52) U.S. Cl. CPC H01H 21/54; H01H 1/42

(57) ABSTRACT

A knife switch device for use in a switchgear or a ring main unit, the knife switch device including a stationary contact member, and a movable contact member, the movable contact member being rotatable about a main revolute joint for selectively opening and closing the knife switch device, the movable contact member including at least a first segment and a second segment, the first segment and the second segment being coupled by an auxiliary revolute joint, wherein the main revolute joint is arranged on the second segment, and wherein a rotation axis of the main revolute joint is substantially parallel to a rotation axis of the auxiliary revolute joint.

### TECHNICAL FIELD

Aspects of the invention relate to a knife switch device for use in a switchgear or a ring main unit, and a method of operating a knife switch device in a switchgear or a ring main unit. A further aspect relates to a switchgear and a ring main unit including the knife switch device.

### BACKGROUND

A switchgear is typically used to connect, disconnect, and protect the power supply line. A switchgear is often equipped with a knife switch. Knife switches can be made up of two, moving contact members closing- and opening on a single fixed contact member. Knife switches are commonly used because of their simple design and low cost. In switchgear and ring main units, knife switches are often as earthing switches.

The critical operation for an earthing switch is to close on the full rated fault current, typically tens of kA, and then open again, without additional force in the operating mechanism. The standardized requirements for most earthing switches is to be able to close and re-open several times in a single test run.

When closing the contacts at high voltage, pre-arcing and Joule heating in the initial contact spots and subsequent cooling may cause the contact members to weld together. If the strength of these metallic connections are larger than the force given by the operating mechanism, the earthing switch will fail to re-open after closing on an earth fault, which will lead to a failed test or faulty operation of the switchgear.

Thus, there is a problem of a failure to open an earthing switch again after closing on a full rated fault current without additional force in the operating mechanism.

### SUMMARY

In view of the above, a knife switch and a method of operating a knife switch is provided.

According to an aspect, there is provided a knife switch device for use in a switchgear or a ring main unit, the knife switch device including a stationary contact member, and a movable contact member, the movable contact member being rotatable about a main revolute joint for selectively opening and closing the knife switch device, the movable contact member including at least a first segment and a second segment, the first segment and the second segment being coupled by an auxiliary revolute joint, wherein the main revolute joint is arranged on the second segment, and wherein a rotation axis of the main revolute joint is substantially parallel to a rotation axis of the auxiliary revolute joint.

Another aspect is directed to a switchgear or ring main unit including the knife switch device.

A further aspect is directed to a method of operating a knife switch device in a switchgear or a ring main unit, the method including actuating, when the knife switch device is in a closed position, a second segment of a movable contact member of the knife switch device through a main revolute joint arranged on the second segment, to switch the knife switch device to an open position, and allowing, when the knife switch device is in a closed position, a first segment of the movable contact member of the knife switch device to rotate about an auxiliary revolute joint to break a weld between the first segment of the movable contact member and a stationary contact member of the knife switch device, the first segment being coupled to the second segment through the auxiliary revolute joint having a rotation axis substantially parallel to a rotation axis of the main revolute joint.

Some effects and advantages are described as follows. A knife switch, according to embodiments described herein, can provide an effect to partially rotate the moving contact knife(s) around the static contact (stationary contact) before separating the moving contact and the fixed contact (stationary contact) in a more linear trajectory. The direct rotating motion can have an effect to tear away potential welds with much less force (requiring less force) than a direct linear pulling motion. As a consequence, the risk of the switch not being able to open after closing on the fault current may be reduced.

Further advantages, features, aspects, and details that can be combined with embodiments described herein are evident from the dependent claims, the description and the drawings.

### BRIEF DESCRIPTION OF THE DRAWINGS:

The details will be described in the following with reference to the figures, wherein

FIG. 1A, FIG. 1B, FIG. 1C, FIG. 1D and FIG. 1E show a closing and an opening operation of the knife switch device according to embodiments described herein,

FIG. 2A, FIG. 2B, and FIG. 2C show various embodiments of the knife switch device as described herein,

FIG. 3 show a knife switch device according to embodiments described herein,

FIG. 4 show a knife switch device according to embodiments described herein,

FIG. 5A, FIG. 5B, FIG. 5C and FIG. 5D show various embodiments of the knife switch device as described herein, and

FIG. 6A and FIG. 6B show a knife switch device according to embodiments described herein.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment applies to a corresponding part or aspect in another embodiment as well.

The reference numbers used in the figures are merely for illustration. The aspects described herein are not limited to any particular embodiment. Instead, any aspect described herein can be combined with any other aspect(s) or embodiment(s) described herein unless specified otherwise.

According to aspects or embodiments described herein, the problem of a failure to open a knife switch or an earthing switch again after closing on a full rated fault current without additional force in the operating mechanism may be avoided. The problem of a failure to open a knife switch or an earthing switch may occur when closing the contacts at high voltage, during which pre-arcing and Joule heating in initial contact spots and subsequent cooling may cause the contact members to weld together.

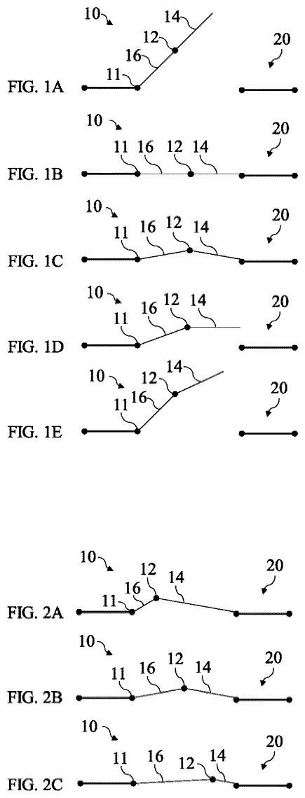

FIG. 1A, FIG. 1B, FIG. 1C, FIG. 1D and FIG. 1E show a closing operation and an opening operation of a knife switch according to embodiments described herein. A knife switch may be a knife switch device or earthing switch according to embodiments. The knife switch device may be suitable for use in a switchgear or a ring main unit. The knife switch device may be suitable for use in a power distribution system. Alternatively, or in addition, the knife switch device may be suitable as an earthing switch.

As shown in FIG. 1A, a knife switch may be in an open position or open state. There may be a movable contact member 10. There may be a fixed contact member, static contact member or stationary contact member 20. The movable contact member 10 may include a main revolute joint 11. The movable contact member 10 may be rotatable about a main revolute joint 11. The movable contact member 10 may be selectively opened and closed. The movable contact member 10 may be rotatable, e.g. about the main revolute joint 11, to be opened and closed. The movable contact member 10 may be rotatable about a main revolute joint 11 for selectively opening and closing the knife switch device.

The movable contact member 10 may include an auxiliary revolute joint 12. The movable contact member 10 may include a first segment 14 and a second segment 16. The first segment 14 and the second segment 16 may be coupled (joined or connected or linked) by an the auxiliary revolute joint 12. The main revolute joint 11 may be arranged on the second segment 16 of the movable contact member 10. A rotation axis of the main revolute joint 11 may be substantially parallel to a rotation axis of the auxiliary revolute joint 12.

The movable contact member 10 may include a first contact surface. The stationary contact member 20 may include a second contact surface. The first contact surface and the second contact surface may contact each other along a contact plane, when the knife switch device is in a closed position. The contact plane may, for example, be defined by at least three non-linearly arranged contact points between the first contact surface and the second contact surface. A rotation axis of the revolute joint 12 and a rotation axis of the main joint 11 may be perpendicular to the contact plane. A rotation axis of the auxiliary revolute joint 12 and a rotation axis of the main joint 11 may be perpendicular to the first contact surface of the movable contact member 10 and/or the second contact surface of the stationary contact member 20. Accordingly, in case of a weld between the contact surfaces, a relative rotation of the first segment 14 about the weld may be enabled thanks to the auxiliary revolute joint 12, thereby allowing the weld to break and thus facilitating opening of the knife switch despite the weld.

There may be an additional pivot point or auxiliary revolute joint 12. An auxiliary revolute joint 12 may be introduced in the moving contact(s), e.g. movable contact member 10. This can have an effect to partially rotate the moving contact knives around the static contact before separating the moving and fixed in a more linear trajectory. The direct rotating motion can tear away the potential welds with much less force than a direct linear pull. As a consequence, the risk of the switch not being able to open after closing on the fault current may be reduced.

The auxiliary revolute joint 12, the first segment 14, and/or the second segment 16 may be freely rotatable about the main revolute joint 11. Accordingly, a relative rotation of the movable contact member 10, e.g. of the first segment 14, about a weld may be provided thereby increasing the chance of the knife switch opening despite the weld.

The second segment 16 may have a first end portion and a second end portion. The main revolute joint 11 may be arranged at the first end portion. The auxiliary revolute joint 12 may be arranged at the second end portion. The first end portion and second end portion may be on opposite ends of the second segment 16. The first segment 14 and second segment 16 of the movable contact member 10 may be arranged in series. Accordingly, a relative rotation of movable contact member 10, e.g. of the first segment 14, about a weld may be provided, thereby increasing the chance of the knife switch opening despite the weld.

The auxiliary revolute joint 12 may be unsupported. The movable contact member 10 may be supported by only the main revolute joint 11, at least in an open configuration of the switch. In a closed configuration of the switch, an additional support of the movable contact member 10 may be the contact between the first segment's contact surface and the stationary contact 20. Other than the above, no further support for the movable contact member 10 may be provided.

In an open configuration of the switch, the first segment 14 is held only by the second segment 16 (e.g., through the auxiliary revolute joint 12). Thereby, when the movable contact member 10 is moved by rotation about the main revolute joint 11 while in the open configuration of the switch, the auxiliary revolute joint 12 is not bent so that an alignment between the first and second segments 14 and 16 remains constant.

As shown in FIG. 1B, a knife switch may be in a closed position or closed state. The movable contact member 10 may be in contact, e.g. electrical contact or physical contact, with the stationary contact member 20. The knife switch may be closed at high voltage. The knife switch may be closed on a current up to a full rated fault current. Pre-arcing and Joule heating may occur at initial contact spots. Subsequent cooling may cause the contact members, e.g. movable contact member 10 and stationary contact member 20, to weld together. The strength of these metallic connections may be large. The knife switch may be operated (actively operated or rotated or opened), e.g. by a rotational force or operating force, via the main revolute joint 11 or only (primarily) via the main revolute joint 11.

As shown in FIG. 1C, a knife switch may be in a closed position or closed state. The knife switch may be partially welded, e.g. the movable contact member 10 may be partially welded to the stationary contact member 20. The knife switch may be in a process (or a start of a process) of being opened.

In embodiments, an additional pivot point (false rotating point) may be added to the center region of the two contact knifes. A small draft of angle, A (angular amount) may be added to the lever supporting the two knives. A draft angle may be implemented by a stopper or rotation restrictor element, e.g. at or acting on the auxiliary revolute joint 12.

In the case that the two knives are welded to the static contact, the initial movement of the lever may be such as to allow the two knives to rotate an angle, A around the static contact, before lifting both knifes directly away from the static contact. This small rotation is considered very effective in tearing apart welds. The chance of re-opening the switch after closing on an earth fault may thus be increased.

As shown in FIG. 1D, a knife switch may be in an open position or open state or in a process of being opened. Alternatively, a knife switch device in a process of being closed may also be as shown in FIG. 1D. There may be a rotation of the first segment 14 about the auxiliary revolute joint 12 relative to the second segment 16. The rotation may assist with the opening of the knife switch.

As shown in FIG. 1E, a knife switch may be in an open position or open state or in a fully open state. Alternatively, a knife switch device in a process of being closed may also be as shown in FIG. 1E.

FIG. 2A, FIG. 2B, and FIG. 2C show various embodiments of the knife switch device as described herein. The auxiliary revolute joint 12 may be arranged at any point on the movable contact member 10.

As shown in FIG. 2A, the auxiliary revolute joint 12 may be arranged nearer (closer) to the main revolute joint 11 than to a first contact surface of the movable contact member 10. Such an arrangement of the auxiliary revolute joint 12 can allow a lower requirement of torque on the movable contact member, e.g. due to the mass of the auxiliary revolute joint 12 being closer to the main revolute joint 11. A mass of the auxiliary revolute joint 12 may include a recovery mechanism (not shown), e.g. spring mechanism, as described in embodiments herein.

As shown in FIG. 2B, the auxiliary revolute joint 12 may alternatively be arranged in substantially in the middle (centre) between the main revolute joint 11 and the first contact surface of the movable contact member 10. Such an arrangement of the auxiliary revolute joint 12 can allow for a suitable balance between a torque needed for rotating the movable contact member 10, and an effectiveness at tearing apart welds.

According to embodiments, depending on the specification of the knife switch, an arrangement of the auxiliary revolute joint 12 other than in the middle (centre) of the movable contact member 10, can also allow for a suitable balance between a torque needed for rotating the movable contact member 10, and an effectiveness at tearing apart welds.

As shown in FIG. 2C, the auxiliary revolute joint 12 may alternatively be arranged nearer (closer) to a first contact surface of the movable contact member 10 than the main revolute joint 11. Such an arrangement of the auxiliary revolute joint 12 can allow a greater effectiveness at tearing apart welds, e.g. due to a relatively greater amount of rotation around the stationary contact member 20.

According to embodiments, which can be combined with other embodiments described herein, a plurality of auxiliary revolute joints 12, e.g. two, may be arranged on the movable contact member 10. Accordingly, the knife switch may be even more effective at tearing away from welds.

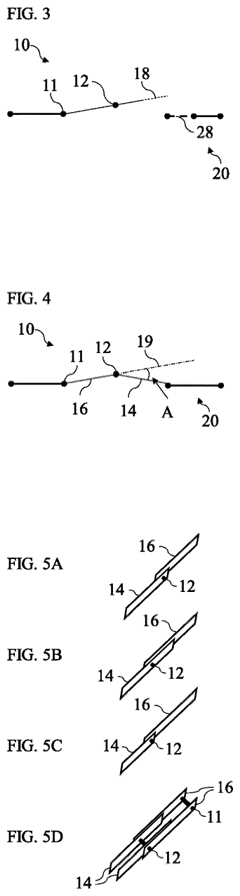

FIG. 3 show a knife switch device according to embodiments described herein. As shown in FIG. 3, at least a portion of the movable contact member 10 and/or stationary contact member 20 may be electrically conductive 18; 28. The movable contact member 10 may include an electrically conductive portion 18. The stationary contact member 20 may include an electrically conductive portion 28.

FIG. 4 show a knife switch device according to embodiments described herein. The first segment 14 may be rotatable relative to the second segment 16 when the knife switch device is in a closed position, e.g. when the knife switch device is being switched from the closed position to an open position.

According to embodiments, there may be a recovery mechanism at or acting on the auxiliary revolute joint 12. A recovery mechanism (not shown), e.g. spring mechanism, may assist in returning the first segment 14 to an initial state (not shown), e.g. collinear or unrotated, relative to the second segment 16 or to an axis 19 of the second segment 16.

The first segment 14 may be not-rotatable relative to the second segment 16 or to an axis 19 of the second segment 16, e.g. when the knife switch device is in a closed position and the movable contact member 10 is moved in any direction other than in a direction for switching the knife switch device to an open position.

The auxiliary revolute joint 12 may allow a rotation of the first segment 14, e.g. of more than 0.5 degrees relative to the second segment 16 or to an axis 19 of the second segment.

The movable contact member 10 may include a stopper. The stopper may restrict a rotation of the first segment 14 (relative to the second segment 16 about the auxiliary revolute joint 11) to a draft angle, A, which may be 45 degrees, 30 degrees, 15 degrees or any other suitable angle.

A larger draft angle, A may provide more rotation about potential welds thereby increasing weld tearing effect. A smaller draft angle, A may improve disconnecting time fora given rotation of the main revolute joint 11. Therefore, a small draft angle such as at most 15 degrees is preferable.

For example, a smaller draft angle, A may allow less rotation of the first segment 14, thus less delay in the disconnection of the electrical contact between the first segment 14 or the movable contact member 10, and the stationary contact member 20, when the knife switch device is being opened (in a closed state proceeding to an open state).

The draft angle A may be an angle covering the allowable rotation (from one end to the other, e.g., from stopper to stopper) of the first segment 14, relative to the second segment 16 or to an axis 19 of the second segment 16. The rotation may be about the auxiliary revolute joint 12.

The stopper may restrict a rotation of the first segment 14 in an angular direction towards the stationary contact member 20, e.g. when the movable contact is in an open state or partially open state or in a process of being opened.

In an example, the first segment 14 is not allowed to rotate further than a draft angle, A (angular amount) towards the stationary contact member 20, e.g. when the movable contact member is in an open state or partially open state or in a process of being opened.

The auxiliary revolute joint 12 may allow a rotation of the first segment 14 relative to the second segment 16 by a draft angle, A (angular amount). A draft angle, A or angular amount, may be an acute angle, and/or an angle between the second segment 16 (or an axis 19 of the second segment 16) and the first segment 14. The draft angle, A (angular amount) may be 45 degrees, preferably 30 degrees, even more preferably 15 degrees, and most preferably 5 degrees. The draft angle or angular amount may be at least 0.5 degrees, preferably at least 1 degree, even more preferably at least 3 degrees, most preferably 5 degrees.

FIG. 5A and FIG. 5B show various embodiments of the knife switch device as described herein. The length of the first segment 14 and second segment 16 of the movable contact member 10 may be any length, and the auxiliary revolute joint 12 may be arranged at various positions on the first segment 14 and second segment 16. There may also two or more of each of the first segment 14 and/or the second segment 16.

As shown in FIG. 5A, the first segment 14 and the second segment 16 may have similar (e.g. within 10%) lengths, and the auxiliary revolute joint 12 may be arranged at an end portion of each segment 14, 16 respectively. For example, the auxiliary revolute joint 12 may be arranged at a second end portion of the second segment 16. The main revolute joint 11 may be at a first end portion of the second segment 16. The second segment 16 may have a blade shape.

In another example which may be combined with other examples, the auxiliary revolute joint 12 may be arranged at a first end portion of the first segment 14. The second end portion may be for making contact with the stationary contact member 20, or for making contact with a portion of the stationary contact member 20. The first segment 14 may have a blade shape.

As shown in FIG. 5B, the auxiliary revolute joint 12 may be arranged substantially at the centre (middle) or at the centre (middle) of the first segment 14. The first segment 14 may have a blade or blade-like shape. One advantage is that the weight or moment of the first segment 14 about the revolute joint 12 is (more) balanced. Another advantage is that the first segment 14 can have a recovery property, e.g. a mechanically stable position or orientation that corresponds to an initial or non-rotated (relative to the second segment 16) state.

In alternative embodiments, the auxiliary revolute joint 14 may not be in the centre of the first segment 14 but in another position that achieves the same advantage of an initial mechanically stable position as described, for example, according to the weight distribution or other relevant parameter of the first segment 14.

The auxiliary revolute joint 12 may be arranged on a second end portion of second segment. The main revolute joint 11 may be on a first end portion of the second segment 16. The second segment 16 may have a blade or blade-like shape. In an alternative, the second segment 16 may also be configured in the same way (balanced/naturally recovering) as the first segment 14.

As shown in FIG. 5C, the first segment 14 and the second segment 16 can have different lengths. An advantage is that the relative rotation of the first segment 14 and second segment 16 can be adjusted for providing different ‘weld tearing’ effectiveness.

As shown in FIG. 5D, a plurality of first segments 14 and second segments 16, e.g. two of each, may be provided. The auxiliary revolute joint 12 and main revolute joint 11 would be arranged on each of the first segment 14 and second segment 16. An advantage is increased contacting surface for lower electrical resistance.

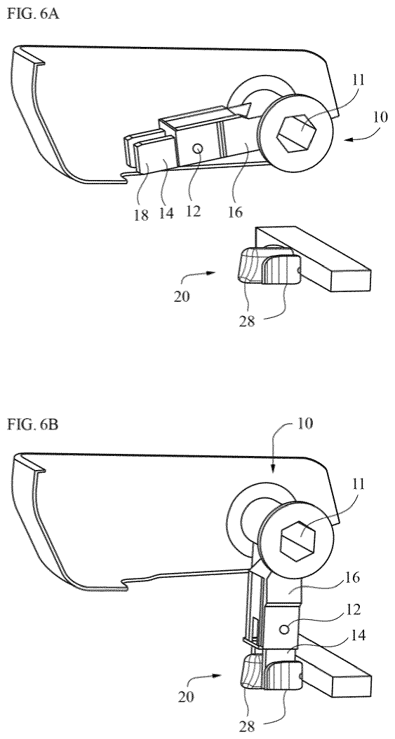

FIG. 6A and FIG. 6B show a knife switch device according to embodiments described herein. The movable contact member 10 may have a blade shape.

As shown in FIG. 5C, the length of the first segment 14 may be different from the length of the second segment 16.

The knife switch device may be rated for a maximum voltage (RMS/AC) voltage in the range 1 kV to 52 kV, preferably 10 kV to 42 kV, and more preferably 12 kV to 24 kV. The voltage range of 1 kV to 52 kV AC can be referred to as medium voltage (MV), see standard EC 62271-103. However, all voltages above 1 kV can be referred to as high voltage (HV).

As shown in FIG. 6A and FIG. 6B, the knife switch device may include more than one, e.g. two (a pair), movable contact members 10. The stationary contact member 20 may include two (a pair) of lateral contact elements. The lateral contact elements may define a space therebetween for inserting the movable contact member(s) 10, e.g. the first segment 14, therein for closing the knife switch device. The lateral contact elements may be arranged for pressing from two opposite sides against the movable contact member(s) 10 inserted in the space laterally.

With exemplary reference to FIG. 6A and FIG. 6B, as an example, the stationary contact member 20 has a nose, which may be conductive, and a clamp, e.g. a lateral clamp, or two clamps. The clamp(s) may be for clamping a portion of the movable contact member(s) (10) against the nose. The clamp(s) may be electrically conductive. Portions of the stationary contact member 20, e.g. nose, and/or clamp(s) may be grounded.

A first contact surface may be arranged on the first segment 14 of the movable contact member 10. A second contact surface may be arranged on the stationary contact member 20. The knife switch device may be configured to be in a respective closed position and open position when at least a portion of the first contact surface is, respectively, in contact and not in contact with at least a portion of the second contact surface.

The knife switch device, as described in embodiments herein, is particularly advantageous for conditions where welding may happen. In embodiments, welding may happen at currents, e.g. maximum peak fault current, of up to 110 kA, e.g. for a peak current (rated) in a range from 40 kA to 62.5 kA. In typical embodiments, peak of fault current may be relevant to making (of fault current).

In embodiments, welding may happen at currents, e.g. maximum RMS short circuit current, of up to 42 kA, e.g. at a current (rated) in a range from 16 kA RMS to 25 kA RMS. In typical embodiments, RMS current may be relevant to short time current (short circuit).

In an example, the knife switch device is rated for a maximum peak fault current of 70 kA and/or a maximum RMS short circuit current of 30 kA.

According to embodiments, there is a method of operating a knife switch device in a switchgear or a ring main unit. The method may include actuating, when the knife switch device is in a closed position, a second segment 16 of a movable contact member 10 of the knife switch device through a main revolute joint 11 arranged on the second segment 16, to switch the knife switch device to an open position.

The method may include allowing, when the knife switch device is in a closed position, a first segment 14 of the movable contact member 10 of the knife switch device to rotate about an auxiliary revolute joint 12 to break a weld between the first segment 14 of the movable contact member 10 and a stationary contact member 20 of the knife switch device, the first segment 14 being coupled to the second segment 16 through the auxiliary revolute joint 12 having a rotation axis substantially parallel to a rotation axis of the main revolute joint 11.

Some effects and advantages are described as follows. A knife switch, according to embodiments described herein, can provide an effect to partially rotate the moving contact knife(s) around the static contact (stationary contact) before separating the moving contact and the fixed contact (stationary contact) in a more linear trajectory. The direct rotating motion can have an effect to tear away potential welds with much less force (requiring less force) than a direct linear pulling motion. As a consequence, the risk of the switch not being able to open after closing on the fault current may be reduced.

Furthermore, a knife switch, according to embodiments described herein, can make simple knife switches even more effective at tearing away from welds. The success rate of such devices in closing and opening operations can be improved. Further, a knife switch, according to embodiments described herein, can comply with higher ratings while being more resource efficient than traditional designs.

1. A knife switch device for use in a switchgear or a ring main unit, the knife switch device comprising:
a stationary contact member, and
a movable contact member, the movable contact member being rotatable about a main revolute joint for selectively opening and closing the knife switch device, the movable contact member comprising:
at least a first segment and a second segment, the first segment and the second segment being coupled by an auxiliary revolute joint,
wherein the main revolute joint is arranged on the second segment, and
wherein a rotation axis of the main revolute joint is substantially parallel to a rotation axis of the auxiliary revolute joint.

2. The knife switch device according to claim 1, wherein the movable contact member has a blade shape.

3. The knife switch device according to claim 1, wherein the stationary contact member comprises a pair of lateral contact elements defining a space therebetween for inserting the movable contact member therein for closing the knife switch device, wherein the lateral contact elements are arranged for pressing from two opposite sides against the movable contact member inserted in the space laterally.

4. The knife switch device according to claim 1, wherein at least a portion of at least one of the movable contact member and the stationary contact member is electrically conductive.

5. The knife switch device according to claim 1, further comprising a first contact surface arranged on the first segment of the movable contact member and a second contact surface arranged on the stationary contact member, wherein the knife switch device is configured to be in a respective closed position and open position when at least a portion of the first contact surface is, respectively, in contact and not in contact with at least a portion of the second contact surface.

6. The knife switch device according to claim 1, wherein the first segment is configured to be rotatable relative to the second segment when the knife switch device is in a closed position and the knife switch device is being switched from the closed position to an open position.

7. The knife switch device according to claim 1, wherein the first segment is configured to be not-rotatable relative to the second segment when the knife switch device is in a closed position and the movable contact member is moved in any direction other than in a direction for switching the knife switch device to an open position.

8. The knife switch device according to claim 1, wherein the auxiliary revolute joint is configured to allow a rotation of the first segment of more than 0.5 degrees relative to the second segment.

9. The knife switch device according to claim 1, wherein the movable contact member comprises a stopper restricting a rotation of the first segment to less than 30 degrees relative to the second segment and about the auxiliary revolute joint.

10. The knife switch device according to claim 1, wherein the auxiliary revolute joint is arranged nearer to a first contact surface of the movable contact member than to the main revolute joint.

11. The knife switch device according to claim 1, wherein the knife switch device is an earthing switch.

12. The knife switch device according to claim 1, wherein the knife switch device is rated for at least one of a maximum peak fault current of 110 kA and/or a maximum RMS short circuit current of 42 kA RMS.

13. A switchgear or ring main unit comprising the knife switch device according to claim 1.

14. A method of operating a knife switch device in a switchgear or a ring main unit, the method comprising
actuating, when the knife switch device is in a closed position, a second segment of a movable contact member of the knife switch device through a main revolute joint arranged on the second segment, to switch the knife switch device to an open position, and
allowing, when the knife switch device is in a closed position, a first segment of the movable contact member of the knife switch device to rotate about an auxiliary revolute joint to break a weld between the first segment of the movable contact member and a stationary contact member of the knife switch device, the first segment being coupled to the second segment through the auxiliary revolute joint having a rotation axis substantially parallel to a rotation axis of the main revolute joint.

15. The knife switch device according to claim 1, wherein the auxiliary revolute joint is freely rotatable about the main revolute joint.

16. The knife switch device according to claim 1, wherein the stationary contact member comprises a pair of lateral contact elements defining a space therebetween for inserting at least a portion of the first segment of the movable contact member therein for closing the knife switch device, wherein the lateral contact elements are arranged for pressing laterally from two opposite sides against at least the portion of the first segment of the movable contact member inserted in the space.
